(19) United States
(12) Patent Application Publication
(10) Pub. No.: US 2009/0095773 A1
(43) Pub. Date: Apr. 16, 2009

(54) Active freeze mitigation cover for personal hydration devices

(75) Inventor: Darren Pinne, Seattle, WA (US)

Correspondence Address: GRAYBEAL JACKSON LLP, 155 - 108TH AVENUE NE, SUITE 350, BELLEVUE, WA, 98004-5973, US

(73) Assignee: Cascade Designs, Inc., Seattle, WA (US)

(21) Appl. No.: 12/286,533

(22) Filed: Sep. 29, 2008

Related U.S. Application Data
(60) Provisional application No. 60/995,892, filed on Sep. 28, 2007.

(51) Int. Cl. B67D 5/63; B65D 25/04; B65D 81/18; B65D 81/38

(52) U.S. Cl. 222/146.2; 220/592.01; 220/592.2; 222/608

(57) ABSTRACT

A cover or enclosure for actively transferring heat energy to at least a distal portion of a fluid conduit and/or bite valve thereof that is part of a personal hydration system, systems incorporating such a cover and related methods. The cover or enclosure includes a first chamber and an adjacent second chamber where a common or adjacent wall, or portion thereof, separates the two. The first chamber is adapted to receive a heat generating element while the second chamber is adapted to removable receive at least the distal portion of the fluid conduit and/or bite valve thereof. The first chamber further includes at least one closure for selectively allowing ingress and egress of the heating means to and from the first chamber. Heating of the distal portion of the fluid conduit and/or bite valve thereof takes place when disposed in the second chamber and the heat generating element is active.

### SUMMARY OF THE INVENTION

The invention is directed to a cover or enclosure for actively transferring heat energy to at least a distal portion of a fluid conduit and/or bite valve thereof that is part of a personal hydration system, systems incorporating such a cover and related methods. Article embodiments of the invention comprise a first chamber and a second chamber adjacent thereto wherein the first chamber and the second chamber have a common or adjacent wall, or portion thereof, and the first chamber is adapted to receive a heating means for generating heat energy while the second chamber is adapted to removable receive at least the distal portion of the fluid conduit and/or bite valve thereof. The first chamber further includes at least one closure means for selectively allowing ingress and egress of the heating means to and from the first chamber.

The invention comprises in another respect methods for preventing freezing of fluid in the distal portion of the fluid conduit and/or bite valve of a personal hydration system or reducing the likelihood of such an event occurring. Accordingly, method embodiments comprise disposing a distal portion of the fluid conduit and/or bite valve of a personal hydration system in a cover comprising a first chamber and a second chamber adjacent thereto wherein the first chamber and the second chamber have a common or adjacent wall, or portion thereof, and the first chamber is adapted to receive a heating means for generating heat energy while the second chamber is adapted to removable receive at least the distal portion of the fluid conduit and/or bite valve thereof.

System embodiments of the invention comprise, in addition to the cover, a personal hydration system having a fluid conduit or tube terminating at a bite valve.

Each chamber in the several cover embodiments comprises at least first and second walls, one of which may be characterized as a wall portion in certain embodiments. Whether exposed to the environment of not, each chamber has at least one outer wall and an inner wall (or inner wall portion), wherein the inner walls of each chamber are either the same wall or are adjacent to each other in order to facilitate the transfer of heat energy from one chamber to the other chamber. The skilled practitioner will of course appreciate that an inner wall may also comprise an opening, in which the remaining structure would be referred to as a wall portion. Each outer wall has an inner side and an outer side; each inner wall at least has an inner side and may further comprise an outer side. Depending upon the embodiment, a chamber, and preferably the first chamber, may have two outer walls, a portion of one outer wall also comprising an inner wall (or an inner wall portion).

Because heat energy is to be transferred from the first chamber to the second chamber, heat energy loss through the first chamber outer wall(s) should be minimized. To that extent, the first chamber outer wall(s) is/are preferably constructed from highly thermally insulative material such as a closed cell foam or neoprene, a material which reduces convective and conductive heat loss, and may further comprise at least one radiant barrier to mitigate radiant mode heat loss, such as aluminized Mylar®. Similar thermal considerations are preferably given to the outer wall of the second chamber. Because heat energy exchange from the first chamber to the second chamber is desired, the inner wall(s) (and/or portions thereof) are preferably thermally transparent or minimally insulating (and preferably less insulating than any outer wall or portion thereof), although such properties are not necessary to the functioning of the invention embodiments. The walls defining the chambers may be homogeneously or heterogeneously rigid, semi-rigid or flexible.

Depending upon the embodiment, thermally conductive means may extend from, or lie adjacent to, the first chamber to or about the second chamber to enhance heat energy transfer from the first chamber to the second chamber. Exemplary means comprise metallic fibers, filaments, coatings (metalized), and similar materials. These thermally conductive means may constitute at least a part of the inner wall(s) and/or extend to the inner side of the second chamber outer wall.

Access to the first chamber can be accomplished through a first opening, which is preferably selectively closeable or occludable (as used herein “occludable” comprises physical means such as two part closure systems that while permitting visual inspection of a heating means inserted into the first chamber, sufficiently block the first opening, thereby preventing unintentional escape of the heating means from the first chamber) using a closure means. While selection of the means used to close and/or occlude the first opening is determined in part by the intended environment of cover use, as well as design considerations, highest insulating values are obtained when the opening is fully closeable, and preferably sealable.

In many embodiments of the invention, the first opening is defined by opposing perimeter portions of the outer walls or of the outer wall and inner wall that define the first chamber. In such embodiments, closure means comprising two part closure systems are particularly suited for use, and include, without preference or limitation, hook and loop systems, toothed slide fastener systems, interlocking channel slide fastener systems as well as snap systems, button systems, clasp systems, etc.

Access to the second chamber can be accomplished through a second opening. The second opening comprises in certain embodiments a portion of the first chamber outer wall outer surface and a peripheral portion of the second opening outer wall, and in other embodiments a peripheral portion of the first chamber outer or inner wall outer surface in combination with a peripheral portion of the second opening outer wall. The skilled practitioner will appreciate that functionally similar configurations exist, for example, second openings defined by the second chamber second wall, and such configurations are considered within the bounds of the invention described herein.

Unlike the first opening of the first chamber, however, the second opening is characterized as facilitating convenient ingress and egress of the distal portion of the fluid conduit and/or bite valve used in a personal hydration system. Consequently, closure and/or occlusion of the second opening is considered undesirable. To the contrary, easy insertion and removal of the distal end of the fluid conduit and/or bite valve is considered desirable in many invention embodiments. To this end, the inner surface of the second opening outer wall may have low friction properties, as well as the inner surface of the second chamber inner wall, if applicable. However, retention means may be incorporated into at least part of the structure defining the second opening to prevent unintended removal of the fluid conduit distal end from the second chamber. Similarly, other portions of the cover may be adapted to function in a similar manner.

The outer side of at least one outer wall of the first chamber in selected embodiments may include attachment means for physically linking the cover to a user or the user's outer gear. The attachment means is usually selected based upon the intended object to which attachment is desired. With respect to personal hydrations systems, the attachment means may comprise a closable loop arrangement the encircle a strap or similar structure often associated with such systems, it may comprise a hook, a carabineer or similar linkage device to engage with a ring associated with the system, or it may comprise one part of a two part attachment systems such as a hook or loop material, among others. While not necessary to the formation of a system, certain system embodiments of the invention comprise the previously described cover and a personal hydration system having a fluid reservoir and a fluid conduit with a distal end to fit within the second chamber of the cover.

The previously referenced heating means preferably comprises a self-contained, pack or pouch having internal compounds that when activated, undergo an exothermic chemical or phase change, thereby evolving heat energy. Such packs or pouches may be reusable or disposable, as the case may be, but are otherwise sized to fit within the first chamber, preferably closely. Thus, certain system embodiments of the invention comprise the previously described cover and the presently described heating means.

For purposes of this patent, the terms “area”, “boundary”, “part”, “portion”, “surface”, “zone”, and their synonyms, equivalents and plural forms, as may be used herein and by way of example, are intended to provide descriptive references or landmarks with respect to the object being described. These and similar or equivalent terms are not intended, nor should be inferred, to delimit or define per se elements of the referenced object, unless specifically stated as such or facially clear from the several drawings and/or the context in which the term(s) is/are used.

### BRIEF DESCRIPTION OF THE FIGURES

FIG. 1 is a perspective view of a cover according to the invention shown engaged with a user's shoulder strap and a distal portion of a personal hydration fluid delivery tube;

FIG. 2 is a perspective view of the cover of FIG. 1 shown in an opened state to reveal a first chamber for receiving a heating pack;

FIG. 3 is a perspective view of the cover of FIG. 2 shown in a closed state after receiving the heating pack;

FIG. 4 is a is a rear elevation view of the cover of FIG. 1 detailing a first type of attachment means; and

FIG. 5 is a rear elevation view of the cover of FIG. 1 detailing a second type of attachment means.

### DETAILED DESCRIPTION

The terminal ends of numeric lead lines in the several drawings, when associated with any structure, references or landmarks described in this section, are intended to representatively identify such structure, references or landmarks with respect to the object being described. They are not intended, nor should be inferred, to delimit or define per se boundaries of the referenced object, unless specifically stated as such or facially clear from the drawings and the context in which the term(s) is/are used. Unless specifically stated as such or facially clear from the several drawings and the context in which the term(s) is/are used, all words and visual aids should be given their common commercial and/or scientific meaning consistent with the context of the disclosure herein.

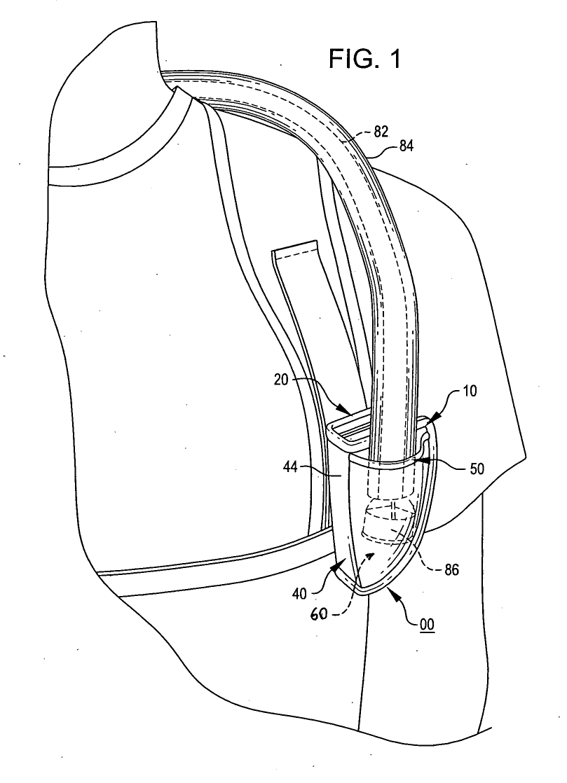

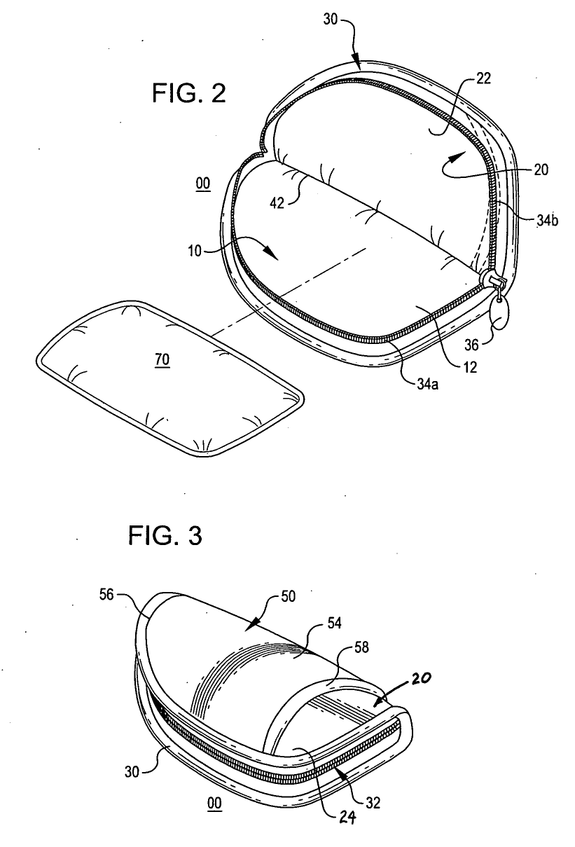

Turning then to the several Figures wherein like numerals indicate like parts, and more particularly to FIGS. 1-3, an embodiment of the invention is show. The perspective view of cover 00 shown in FIG. 1 identifies many of the major components thereof: first chamber outer panel 10, which constitutes a first chamber first wall in this embodiment, first chamber inner panel 20, which constitutes a first chamber second wall in this embodiment, perimeter portion 30, spine 40, second chamber outer panel 50, which constitutes a second chamber first wall in this embodiment, second chamber inner panel 60, which constitutes a second chamber second wall portion in this embodiment, and heating element 70. Note that in the illustrated embodiment, panels 10 and 20 are constructed from a single panel of material although they are differentiated herein for illustrative purposes.

First chamber outer panel 10 includes inner side 12 and outer side 14 while first chamber inner panel 20 includes inner side 22 and outer side 24. Note that in the illustrated embodiment, a portion of inner panel 20 also functions as inner panel 60 with respect to the second chamber defined further by outer panel 50. Thus, outer side 24 also functions as an inner side to the second chamber. Perimeter 30 generally defines an opening for the first chamber, and functions to provide an attachment location for teeth 34a and 34b of slide fastener system 36. Therefore, upon substantially complete disengagement between teeth 34a and 34b, a sufficient opening exists to insert or remove heating element 70; upon substantially complete engagement between teeth 34a and 34b, heating element 70 is releasable retained in the first chamber and additionally insulated from the external environment. Completing the general structure associated with the first chamber is spine 40, which includes inner portion 42 and outer portion 44.

As noted above, cover 00 includes a second chamber that is defined by second chamber outer panel 50, which constitutes a second chamber first wall, and second chamber inner panel 60, which constitutes a second chamber second wall portion in this embodiment. Depending upon applications and environments, the thermal transmission properties of inner panel 60 (and therefore also at least the corresponding opposed portion of inner panel 20) can be tailored to provide optimal heat energy transfer rates from the first chamber to the second chamber. Second chamber outer panel 50 includes an inner side (not shown) and outer side 54, as well as perimeter 58 that, in conjunction with outer surface 24, defines an opening to the second chamber through which bite valve 86 and optionally a portion of hose 82 may be introduced (see FIG. 1). Although the second chamber opening is illustrated to be of sufficient dimensions to accept hose 82 and insulation covering 84, it need only be of sufficient dimensions to accept bite valve 86 in order to achieve functionality, as is the case with the second chamber.

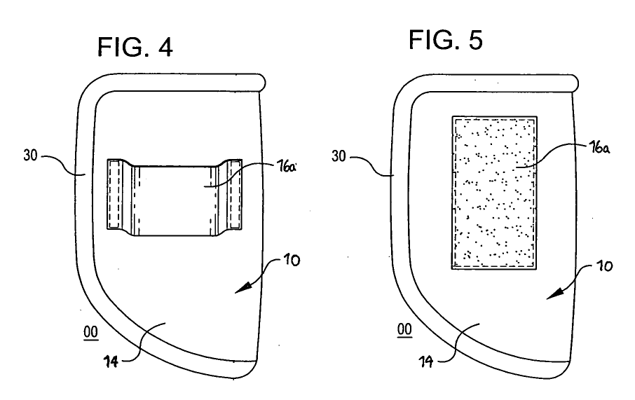

Referring to FIGS. 4 and 5, several exemplary modes for attaching cover 00 to an auxiliary structure are shown. In FIG. 4, fixed loop 16a is shown attached to outer surface 14 of panel 10. By threading a strap, such as found on a personal hydration system harness, through loop 16a, a secure means for associating cover 00 therewith can be achieve. Similarly, loop material 16b, which is fixedly attached to outer surface 14 of panel 10 can be linked to complementary hook material fixedly attached to an auxiliary structure to create a desired attachment means, as will be appreciated by those persons skilled in the art.

What is claimed:

1. A cover for a fluid conduit and/or bite valve in a personal hydration system comprising:
a first outer wall and one of a first inner wall or a first inner/outer wall combination that together substantially define a first chamber for receiving heat generating means wherein the first outer wall includes an inner surface and an outer surface, and wherein the first inner wall or the first inner/outer wall combination includes an inner surface and an outer surface; and
a second outer wall and a second inner wall that together substantially define a second chamber for receiving a distal portion of the fluid conduit wherein the second outer wall includes an inner surface and an outer surface.

2. The cover of claim 1 wherein the first and second inner walls comprise a single element.

3. The cover of claim 1 wherein the first and second inner walls comprise distinct elements in proximate relationship to each other.

4. The cover of claim 1 wherein the first outer wall and one of a first inner wall or a first inner/outer wall combination comprise a single element.

5. The cover of claim 1 further comprising closure means associated with the first outer wall and one of the first inner wall or the first inner/outer wall combination to provide selective access to the first chamber.

6. The cover of claim 5 wherein the closure means occludes the first chamber.

7. The cover of claim 5 wherein the closure means substantially seals the first chamber.

8. The cover of claim 5 wherein portions of the second outer wall and the second inner wall define an opening sized to receive the distal portion of the fluid conduit.

9. The cover of claim further comprising heat energy conduction means to enhance heat energy transfer between the first chamber and the second chamber.

10. The cover of claim 1 further comprising attachment means for linking the cover to an auxiliary structure.

11. The cover of claim 1 wherein the first inner wall, or inner wall portion, and/or the second inner wall have a greater thermal transmission ability than either the first outer wall or the second outer wall.

12. The cover of claim 1 wherein a heat transfer rate between the first chamber and the second chamber is greater than a heat transfer rate between the first chamber and the environment or between the second chamber and the environment.

13. A system comprising the cover of claim 1 and a heating element as the heating means, sized to fit within the first chamber.

14. The system of claim 13 wherein the heating element generates heat through an exothermic chemical reaction.

15. A personal hydration system comprising the cover, the fluid conduit and the bite valve of claim 1, and further comprising a fluid reservoir fluidly coupleable to the fluid conduit.

16. A method of increasing the temperature of a fluid conduit and/or bite valve of a personal hydration device comprising:
inserting a heating element into a cover comprising a first outer wall and one of a first inner wall or a first inner/outer wall combination that together substantially define a first chamber sized to receive the heating element; and a second outer wall and a second inner wall that together substantially define a second chamber; and
inserting a distal portion of the fluid conduit and/or bite valve into the second chamber.

17. The method of claim 16 wherein the heating element is activated prior to insertion into the first chamber.

18. The method of claim 16 further comprising attaching the cover to an article worn by the user.
